(19) United States
(12) Patent Application Publication
(10) Pub. No.: US 2003/0056225 A1
(43) Pub. Date: Mar. 20, 2003

(54) Remote control method and system for operating devices served by a modular multi-media converged services portal

(76) Inventor: Angelo A. Bione, Lawrenceville, GA (US)

Correspondence Address: ARRIS International, Inc., 11450 Technology Circle, Duluth, GA, 30097, US

(21) Appl. No.: 10/245,157

(22) Filed: Sep. 17, 2002

Related U.S. Application Data
(60) Provisional application No. 60/322,918, filed on Sep. 18, 2001.

(51) Int. Cl. H04N 7/173

(52) U.S. Cl. 725/116; 725/93; 725/98; 725/118; 348/211.99

(57) ABSTRACT

A remote transmitter and receiver for remotely controlling multimedia devices served by a converged multi-media portal for coupling a plurality of multi-media signals carried on a single network medium to a plurality of corresponding multi-media devices. Each device is served by a multi-media processing modules, which receives a multi-media signal from a network interface module and routes at least one multi-media signal to a corresponding multi-media device. Each module may comprise a remote control receiver. Alternatively, a separate control module that serves other multi-media processing modules may comprise a single receiver.

An instruction message is generated by the transmitter based on user input. The instruction message may be combined with an address message to provide device selectability when proximate transmitters and receivers corresponding to different devices operate at the same RF carrier frequency.

### CROSS REFERENCE TO RELATED APPLICATION

This application claims the benefit of priority under 35 U.S.C. 119(e) to the filing date of Bione, U.S. provisional patent application No. 60/322,918 entitled “Full Duplex Fiber System To The Home”, which was filed Sep. 18, 2001, and is incorporated herein by reference.

### BACKGROUND OF THE INVENTION

Many distribution networks are now being used to distribute entertainment content (e.g., broadcast television programming, movie channels), bi-directional data (e.g., internet access, e-mail services) and telephony (e.g., voice-over-internet protocol). These disparate forms of information (i.e., “multi-media”) can be carried together using a variety of transmission methodologies over a variety of media. Hybrid Fiber Coax, Fiber-to-the-home/curb/business, Fixed Wireless, Digital Subscriber Line, twisted copper wires are media types over which different information forms can be carried. Each transmission media and each transmission technology has certain strengths and weaknesses and for that reason, consumers that receive different services over different media need to have equipment that can be coupled to the media.

This creates a number of problems for end users. Different service providers means different bills, different payments schedules and different service departments from which help might need to be summoned.

It is anticipated that consumers will eventually want and expect all of their multi-media services from a single provider, such as a cable service provider. Convergence of disparate forms of information on a single media will eventually happen. When it does, consumers will still be faced with the technical challenge of recovering, distributing and using disparate information streams at the customer's premises.

A converged services portal, which enables end-users to quickly and economically add and/or delete multi-media services and enable them to readily enjoy disparate multi-media services would facilitate the adoption of multi-media service over distribution networks like existing cable television networks.

### BRIEF DESCRIPTION OF THE DRAWINGS

The teachings of the invention can be readily understood by considering the following detailed description in conjunction with the accompanied drawings, in which:

FIG. 1 illustrates a converged service portal block diagram, in accordance with one embodiment of the present invention;

FIG. 2 illustrates, in a perspective view, the backplane and plurality of connectors of the converged multi-media portal of the present invention;

FIG. 3 illustrates, in a perspective view, the backplane and plurality of connectors having a network interface module and a multi-media processing module attached thereon;

FIG. 4 illustrates the converged service portal of FIG. 2 having the network interface module and a plurality of multi-media processing modules contained thereon; and

FIG. 5 illustrates, in perspective view, a cabinet of the converged services portal in accordance with one embodiment of the present invention.

FIG. 6 illustrates a block diagram for components that implement a remote control transmitter for remotely controlling the converged services portal.

FIG. 7 illustrates a block diagram for components that implement a remote control receiver for remotely controlling the converged services portal.

### DETAILED DESCRIPTION

There is provided herein, a modular converged multi-media services portal, which provides a modular interface between a distribution network, such as a cable television network and multi-media devices and equipment, such as computers, telephones, audio and video equipment, security and monitoring equipment, etc. The converged multi-media services portal includes a network interface device, which receives data from distribution network for a particular type of multi-media signal and routes the signal to the appropriate multi-media signal distribution unit.

Disparate bi-directional and uni-directional multi-media signals, which are embodied as different data streams on a distribution network, are processed by the network interface module. An incoming data stream of data packets (one that is sent into the portal from a distribution network) is routed by the network interface to an appropriate multi-media module. From there, the multi-media module recovers from the data packets of the data stream, a signal that can be used by multi-media-signal using devices.

By way of example, the information (i.e., program content) that would ordinarily be carried on a broadcast television RF signal can be carried on a distribution network as a stream of data packets, the transmission of which comprises an information stream. The data packets that contain the broadcast television signal information are routed to a television multi-media module, which reconstructs a broadcast television radio frequency signal from the data packets and generates that signal for distribution at the customer premises and for demodulation by a standard broadcast television receiver.

Different multi-media services can be added or deleted to a consumer's premises by simply adding or removing different modular multi-media modules from the converged multi-media services portal. The converged multi-media services portal can be embodied as a weather-proof, outdoor cabinet or an indoor cabinet, wall-mounted or table-top modular enclosure housing the electronics for recovering multi-media signals at the customer premises from data streams provided from a distribution network.

The converged services portal can be used to deliver multiple lines of wired and/or wireless telephony, high-speed data, and/or multi-media services to either an end-user's home or office, referred to as a single dwelling unit or SDU. It can also be used at apartments or office complexes referred to as multiple dwelling unit or MDU. In either case, the converged multi-media services portal provides ready distribution of multi-media signals from a single distribution network source (e.g. xDSL, FTTx, HFC, Fixed Wireless, etc).

The converged multi-media services portal can support a variety of network interface options, including but not limited to, DOCSIS cable modem, Digital Subscriber Line modem, Fiber-to-the-x modem, or a fixed wireless modem. The converged multi-media services portal also supports modular multi-media modules that include, but are not limited to, powerline/802.11x/Ethernet/HomePNA access point, set-top box-like video module, IP streaming video module, network storage jukebox, voice-over-ip MTA, etc.

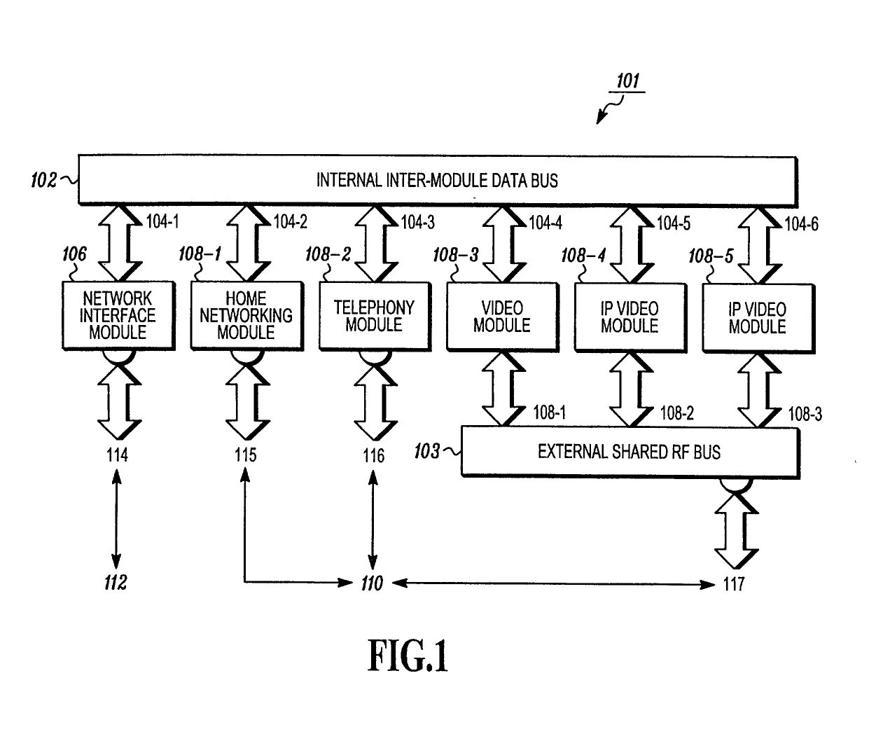

FIG. 1 illustrates a block diagram representing a converged multi-media services portal that provides for the addition or deletion of equipment required to take advantage of disparate multi-media information carried over a distribution network medium. The portal is comprised of a cabinet 101 that encloses a backplane 102, to which there are electrically and mechanically attached, several electrical connectors, six of which are shown and identified by reference numerals 104-1 through 104-6. The connectors are preferably comprised of electrically insulating material that fixes concealed electrical contacts that make electrical contact with mating conductive surfaces on a circuit board inserted into the connector. The connectors 104 and conductive pathways (not shown but well-known to those of skill in the art) on the backplane 102 enable signals to be exchanged, (i.e., transferred) between modules plugged into the various connectors.

The electrical connectors 104 accommodate at least one network interface module 106 and one or more multi-media processing modules 108. The multi-media modules typically receive data from the network interface module and generate from the received data, multi-media signals for use by a corresponding multi-media device. By way of example, one type of multi-media module can receive data packets from the network interface module that represent the content of a broadcast television program. When these data packets are received by a broadcast television multi-media processing module, it takes the data packets and can either re-create a broadcast television signal by converting the data to an analog signal and modulating it onto an RF carrier, or, it can take the data signal and create video and audio signals for a television.

Examples of different types of multi-media devices, each of which would be coupled to a corresponding multi-media module 108 are, television receivers or audio equipment, a telephone (POTS-type), a computer modem. Each multi-media processing module 108 is designed to generate a particular multi-media signal from the data it receives and each such module is therefore coupled to at least one corresponding multi-media device. Other embodiments of multi-media modules would include the ability to send data from a multi-media device, to the network interface module 106 for transmission onto the distribution network.

In a preferred embodiment, which contemplates the transmission and reception of multi-media signals using a transmission protocol such as TCP/UDP/IP to move data packets, the network interface module 106 acts like a bridge, directing data packets from various multi-media sources both within the home network 115 or distribution network 114 to the appropriate multi-media processing modules within the portal or distribution network 114 using source and/or destination address data embedded in data packets. All multi-media modules 108 will of course have an unique address to which data packets can be sent and from which data packets can be received.

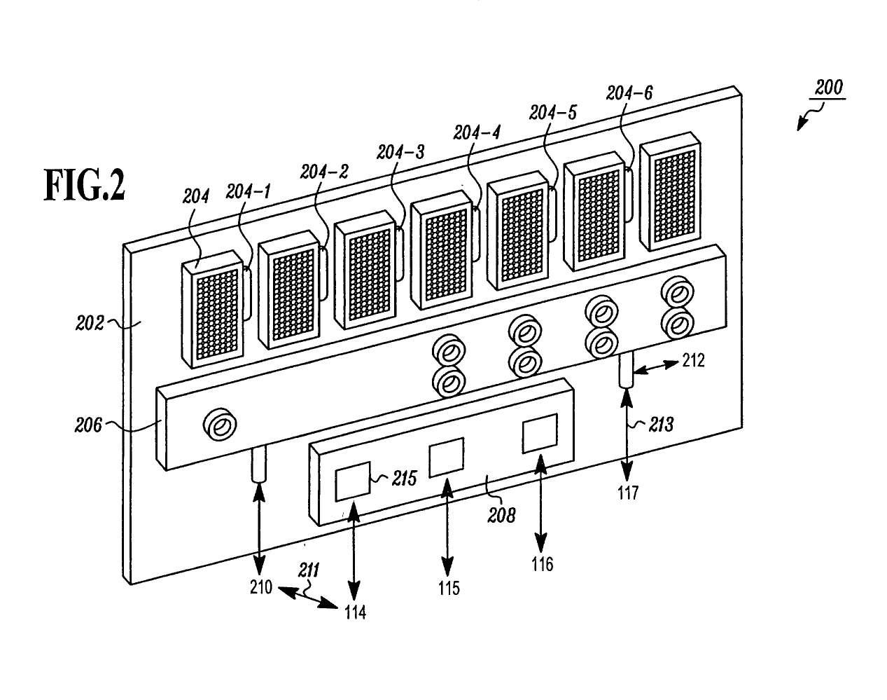

When installed into a connector 104 in the backplane 102, the multi-media modules 108 can be operatively coupled to corresponding multi-media devices (televisions, computers, cameras, etc., as set forth more fully below) throughout the customer's premises and be considered to be multi-media sources with respect to the multi-media devices in that each module receives its own data and from that data processes it to obtain a certain type of multi-media content or information. (The backplane identified in FIG. 1 by reference numeral 102 is also depicted in FIG. 2, where it is identified by reference numeral 202.)

Each of the electrical connectors 104-1 through 104-7 are coupled to electrical signal paths, such as conductive traces on or in a circuit board or discrete wires that form a bus over which data signals can be sent to, or received from other modules plugged into connectors at the same time. The electrically-conductive elements of the connectors 104-1 and 104-7 (well-known to those of skill in the art) can also be considered to be part of a bus. The electrical connectors 104-1 through 104-7 can be used to accommodate disparate multi-media processing modules of which there can be several different types, 108-1 through 108-6.

In the preferred embodiment, the connectors 104-1 through 104-7 are physical receptacles, capable of having the network interface module 106 or the multi-media processing modules 108-1-108-6 installed therein.

The converged multi-media services portal is preferably disposed within a cabinet 101, for conveniently and securely enclosing the multi-media service modules and the network interface module in a single, central location. If a user wishes to add or eliminate a multi-media service (presumably available on one or more media, such as a coaxial cable or fiber optic cable or two-way radio link, to which the network interface module is coupled) thereby necessitating adding or removing a multi-media processing module, the multi-media processing modules can be added or removed simply by installing the appropriate multi-media module in any available connector 104 or by removing the appropriate multi-media module, thereby eliminating the need for the addressability to the network interface module 106, the expense associated with a service call, as well as adjustments in interior wiring. Moreover, the converged multi-media services portal provides for a single network interface for a consumer's premises, whereby various multi-media devices may utilize a single network for convenient communication with an outside communication or service network.

In accordance with the preferred embodiment of the present invention, corresponding multi-media devices may include, but are not limited to, one or more personal computers, a personal digital assistant (PDA), a computer peripheral such as a printer or scanner, a fax machine, at least one web appliance, a heating, ventilation and air-conditioning system, lighting system, utility meters, security system, a fire extinguishing system, home gaming system, a television, a radio, audio device, intercom, household appliance, doors, windows, cameras, telephones, law sprinklers, or any other electronically controllable home system, all of which are well-known.

The backplane 102 is preferably any appropriate substrate to which the connectors 104 can be mounted and interconnected via conductive pathways between them. The conductive pathways (not shown) between connectors 104 can be in, or on the substrate. Although they are not shown in the figures, electrically conductive traces on a circuit board are well-known to those of skill in the art. Such traces are also known to be used to comprise a bus.

The connectors 104 (which are also known as edge connectors) and the backplane 102 function to couple together, circuits that can be mounted on various circuit boards plugged into the connectors 104. For purposes of claim construction, the term “module” should be construed to mean a circuit board or other substrate or carrier, (e.g., fiberglass, ceramic, resin, etc. or electrical conductors, such as pins or wires) that plugs into a mating connector 104, and any circuitry mounted thereon which performs one or more particular functions. The network interface module and multi-media processing modules are therefore considered to be circuit boards, substrates or other carriers. Some multi-media processing modules can send an information signal to the network interface module as well as exchange signals between them. The backplane 102 enables communication between the network interface module 106 and the multi-media processing modules 108-1 through 108-6.

In a preferred embodiment, the network interface module 106 receives transmission signals or data (e.g., TCP/UDP/IP data packets) 112 from a distribution network 114, such as, but not limited to, the service provider's network or Internet, although a wide-area network or Intranets are other forms of a distribution network. The signals of the distribution network are preferably sent via a media such as a coaxial cable, fiber optic cable, a hybrid-fiber coax network, wired or wireless transmission path.

The network interface module 106 receives the data signal 112 and distributes the multi-media signals contained therein to appropriate multi-media processing modules 108-1 through 108-6 using information from the data signal 112. Inasmuch as the multi-media signals are preferably TCP/UDP/IP, the particular multi-media processing modules to which a signal is to be routed can be determined by either a source address, a destination address or both. The multi-media signals are thus provided to the corresponding multi-media devices (e.g., a telephone, or voice-over-IP telephone, television, computer, PDA, camera, heating or air conditioning system, security system, etc.,) 110 according to information included with the multi-media signals, using wired or wireless connections provided at the consumer's premises.

As set forth above, the multi-media signals within the data signal 112 contain multi-media signal addresses, such as those used in the transmission control protocol/internet protocol (TCP/IP). Those of skill in the art will recognize that extended IPv6 addresses could be used as well.

By way of example, the network interface module 106 may receive a signal 112, containing packets of a first data stream for an Internet web browser as well as packets for a second data stream for a broadcast television channel. The first data stream for an internet web browser will need to be routed to a multi-media device that translates data packets (e.g. TCP/UDP/IP) for use by a personal computer. The network interface module 106 routes the data stream of the first multi-media signal to the first multi-media processing module 108-1 through connector 104-1, over the backplane 102, to connector 104-2. The network interface module 106 also routes the second data stream of the second multi-media signal to the third multi-media processing module 108-3, over the backplane 102 through the connector 104-1 and connector 104-4.

The first multi-media processing module 108-1 provides a first multi-media signal to the first multi-media device 110-1 (e.g., personal computer) and the third multi-media processing module 108-3 may provide the second multi-media signal to the third multi-media device 110-3 (e.g., a television receiver). Furthermore, the multi-media devices 110-1 through 110-3 may be in communication with each other across the backplane 102, via connectors 104-2 through 104-4, respectively. As well, the multi-media modules 108-1 through 108-6 may be in communication with each other across the backplane 102, via connectors 104-2 through 104-7, respectively.

As is well-known in data networks, upon the initialization of communication between one of the multi-media devices 110-1 through 110-3 and the distribution network (referred to herein as the distribution network 114), each multi-media processing module 108-1 through 108-6 can acquire a dynamically allocated address (e.g. TCP/UDP/IP). This address may be generated by, but not limited to, the network interface module 106 or derived via a system on the distribution network 114. This address is utilized by the distribution network 114 to properly and effectively transfer multi-media signals to the multi-media devices 110. While in a preferred embodiment, addresses are dynamically allocated, in an alternative embodiment, the multi-media processing modules 108-1 through 108-6 can contain a static address.

FIG. 2 illustrates, in perspective view, a converged services portal 200 having a backplane 202 and a plurality of connectors 204-1 through 204-7. The backplane 202 further includes a radio frequency (RF) bus or interface 206 and a wireline interface 208.

The radio frequency interface 206 includes a coaxial cable input connector 210 to receive a coaxial cable input, such as across a broadband connection using a coaxial cable 211 from the distribution network 114. The radio frequency interface 206 further includes a coaxial cable output connector 212 to provide an output data signal across a coaxial cable 213 to the home RF network 117. Moreover, the wire interface 208 may provide communication with the distribution network 114 across a wired connection 215.

The coaxial cable connectors 210 and 212 provide RF signal connection points and pathway to and from modules plugged into the connectors 204 of the backplane 202. An RF signal on a coaxial cable plugged into the connector 210 can be picked up by a network interface module 106 so as to enable the network interface module to process signals it recovers from the cable.

When a multi-media signal, such as signal 112 of FIG. 1, is provided to the backplane 202, the multi-media signal is provided to a network interface module 106 through the backplane 202. Access to the multi-media signals of a distribution network, such as a CATV network, can be provided by whatever media and communications protocol are used on the distribution network so long as the network interface module 106 can process the signals. As discussed above, the multi-media signal may be provided from the distribution network across a coaxial cable 211, a fiber optic cable, across a wired connection 215, or across a wireless communication network 217 via a wireless network interface module.

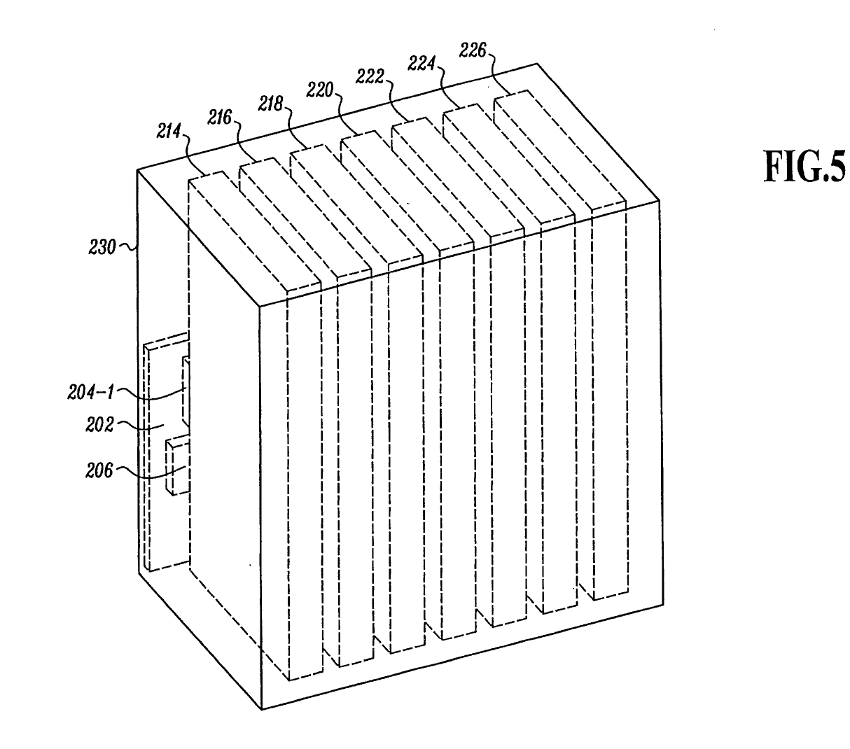

The backplane 202 electrically and physically supports the various connectors 204-1 through 204-7 so as to allow circuit boards, i.e., the aforementioned modules, to be mounted in them. The connectors 204-1 through 204-7 preferably can accept either a network interface module or one of a plurality of multi-media processing modules (not illustrated in FIG. 2). Furthermore, not shown for clarity purposes only, the converged services portal 200 is disposed within a cabinet, as discussed below with reference to FIG. 5.

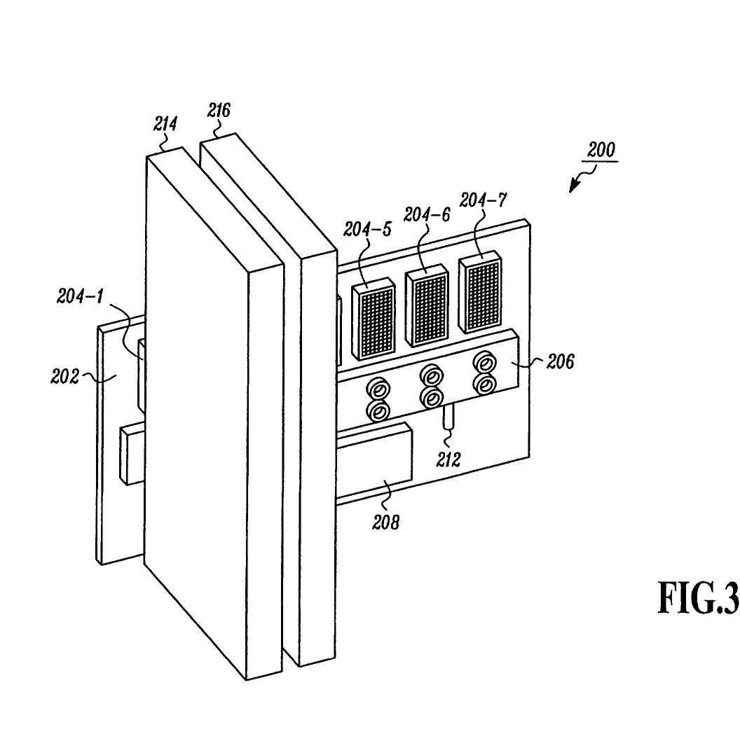

FIG. 3 illustrates the converged services portal 200 and the backplane 202 having a network interface module (identified in FIG. 3 by reference numeral 214) coupled into the first connector 204-1. FIG. 3 further illustrates a single multi-media processing module (identified in FIG. 3 by reference numeral 216) connected to the backplane 202 via a second connector, element 204-2 of FIG. 2, but not visible within FIG. 3. As shown, the backplane 202 may accept further multi-media processing modules in the connectors 204-2 through 204-7. For clarity purposes only, the connections between the backplane 202 and the distribution network, as discussed with reference to FIG. 2, have been omitted.

As set forth above, the network interface module 214 acts as a bridge between a multi-media device coupled to the multi-media processing module 216 and the distribution network 114, shown in FIG. 1. Inasmuch as the purpose of the disclosed and claimed invention is to facilitate the distribution and use of multi-media signals, the multi-media devices to which multi-media signals are delivered are preferably co-located at a subscriber's premises. Examples of co-located converged services portal and multi-media devices include, but are not limited to, a converged services portal mounted on an exterior wall, or in a utility closet of a subscriber's residence, to which a coaxial cable or fiber optic cable is connected. Multi-media devices of all kinds and used through out a residence needs only be wired to the cabinet to obtain disparate multi-media signals, without each device requiring its own addressability.

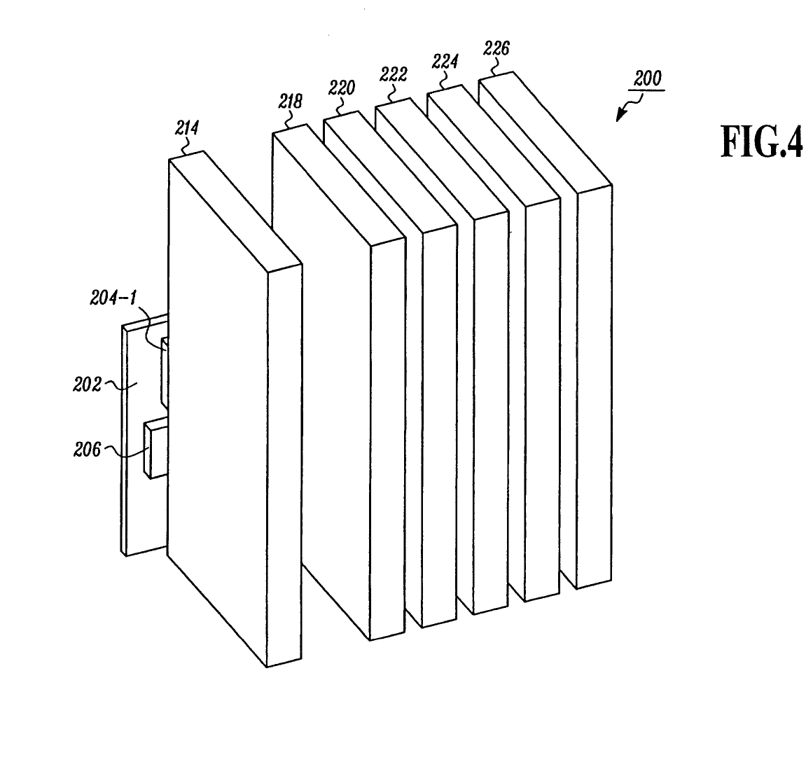

FIG. 4 illustrates the converged services portal 200 having the network interface module 214 shown in FIG. 3, and a plurality of multi-media processing modules 218-226 connected to corresponding connectors 204-1, 204-3 through 204-7 (not visible) on the backplane 202. As with FIG. 3, for clarity purposes only, the distribution network and communication paths, such as 211, 213, 215 and 217 have been omitted. In accordance with the present invention, the network interface module 214 is in communication with the multi-media processing modules 218-226 through the backplane 202.

As discussed above, a data signal, identified in FIG. 1 by reference numeral 112, can have different multi-media signals contained therein. The data signal 112 is received by the network interface module 214. The network interface module 214 routes the data packets of a multi-media signal to the corresponding multi-media processing module 218-226 based on embedded multi-media signal addresses. In other words, data packets of a television signal are routed to a television multi-media processing module; data packets for a web browser or an e-mail are routed to a cable modem or other modem module. Furthermore, the specific multi-media devices, such as 110 of FIG. 1, may be in communication with each other through the corresponding multi-media processing modules 218-226, across the backplane 202.

FIG. 5 illustrates a cabinet 230 having a converged services portal 200 disposed therein. For illustration purposes only, the converged services portal 200 is made visible through the cabinet, shown in phantom view. The cabinet 230 provides a closed environment for the converged services portal 200 to be disposed therein. In one embodiment of the present invention, the cabinet 230 is of a weather-resistant construction using weather-resistant materials. Such a cabinet could be used indoors or outdoors, wall-mounted or tabletop mounted.

The cabinet 230 may be constructed of a material allowing the box 230 to be installed indoors, such as within a housing unit, for example in close proximity to a fuse box. The cabinet 230 provides a closed environment having openings for an input coaxial cable line, an output coaxial cable line, power supply lines, wired lines, such as a telephone line, and a plurality of output transmission lines coupling the multi-media processing modules to the multi-media processing devices.

The present invention provides a converged services portal, which readily allows for disposition of multi-media signals at a multi-media subscriber's (e.g., a consumer's) premises. Adding or deleting a multi-media service is readily accomplished by simply adding or deleting a multi-media processing module 216-226 and coupling a multi-media device 110 to the appropriate processing module, and thereafter enjoying the experience provided by the multi-media service. The present invention allows a user to quickly and inexpensively interchange network interface modules and multi-media processing modules within the converged services portal 200 without having to rewire an internal wiring system or otherwise adjust any internal connections to the plurality of multi-media devices, but rather simply open the cabinet 230 and insert a network processing module 214 or a multi-media processing module 218-226 therein.

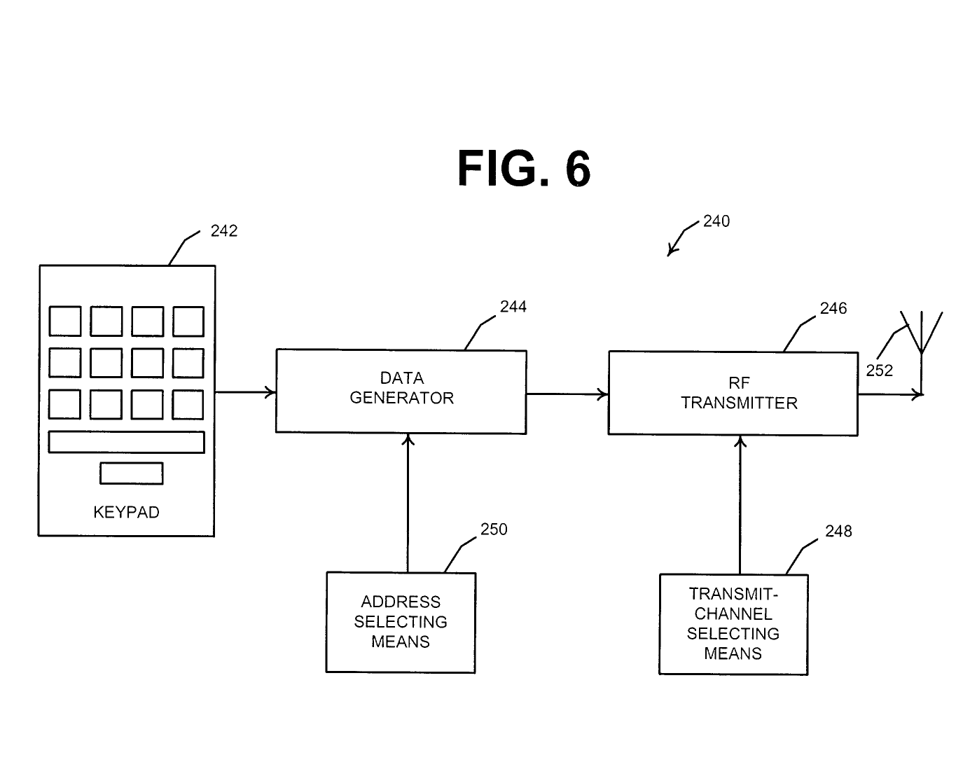

Turning now to FIG. 6, a remote control transmitter 240 is illustrated. The remote control transmitter 240 will typically communicate with a receiver wirelessly, with the preferred mode of transmitting information being via radio frequency signals. To provide instruction remotely to a television or other device served by a converged services portal as discussed above, a user enters information into a user interface 242. Interface 242 may typically be a keypad, but may also comprise a keyboard of a personal computer, a personal digital assistant, or even a telephone keypad. The information input by the user into interface 242 is received by data generator 244 that generates an instruction message to be transmitted to a receiver. When a button, or sequence of buttons, of interface 242 is pressed, the data generator 244 creates a digital transmission message providing instruction for action by a device associated with the receiver.

The message generated by data generator 244 is then sent to the RF Transmitter 246, which is tuned for a specific frequency as selected on the remote control device 240. Selection of the frequency is accomplished by frequency selecting means 248. The frequency is selected to match the resonant frequency at a receiver associated with the device to which the action message is directed. Address selecting means 250 may also be used to determine a particular receiver for which a certain action is directed.

For example, if a user watching television in a den wishes to change the channel, the user would select the desired television channel with user interface 242. The data generator 244 would generate the appropriate channel-select-message to be sent to the module with which the den television is associated at the converged services portal. The RF transmitter 246, having been previously configured so that it's transmit carrier frequency matches the tuned circuit frequency of the module receiver front end, transmits a signal at the predetermined frequency. The desired receiver then detects the signal and the selected action is performed, e.g., changing the channel.

However, in another scenario, for example, two adjacent tenants in an apartment may be watching television simultaneously. Due to a limited number of different transmit frequencies that are available, and the relatively large number of users in close proximity, as opposed to residents living in discrete homes in a suburb, for example, the modules associated with each respective television of the two apartment neighbors may be tuned to the same transmit frequency. Thus, when one neighbor selects a television channel that is different from the channel the other neighbor is watching, both televisions would change to the channel selected by the first neighbor.

To avoid the undesirable effects of this scenario, address-selecting means 250 may also be used to provide additional differentiation of modules being selected. For example, even if the modules corresponding to the two televisions of the two neighbors are tuned to the same frequency, each module may have a unique address within the converged services portal. Since it is likely that the modules for both televisions are located within the same the same converged services portal, each module may be assigned a different address merely by being located in a different slot of the converged services portal. Or, the network interface module 214 may work in concert with the receiver to direct an instruction to the appropriate module by acting upon an address code, which may have been generated by the data generator 244 based upon an address message from address selecting means 250 and sent as part of the channel-select-instruction message by remote control 240. The combined user instruction and address messages may be referred to as a composite message. The address selecting means 250 may be, for example, a PROM programmed during manufacturing or by a network operator before delivery to the end user, jumpers, or DIP switches that are set before delivery to an end user or by the user after delivery.

Alternatively, the address selecting means may be user programmable by entering information with the user interface 242. The data generator 244 receives the information that the user inputs into interface 242 and programs the address selecting means 250 in accordance with the information entered by the user. Thus, if the user upgrades a multi-media processing module or installs an additional module because a new television has been added to the home, for example, the remote control device 240 can be updated too, so that control of the added television is supported by the remote control device.

Address selecting means 250 may be indexed according to a code/keystroke or a code/keystroke sequence. If the address selection means 250 comprises a PROM, for example, pressing a button on interface 242 would send a particular code to the address selection means. Address selection means 250 would then find the code, retrieve an address associated with the code, and then send the address to the data generator 244. If the address selection means 250 comprises an arrangement of jumpers or switches, the code sent by interface 242 would be recognized by the address selection means as corresponding to the particular jumper or switch setting(s) and the address selection means would cause the appropriate address to be sent to the data generator 244. Data generator 244 merges the device address information with the desired action information and sends the combined information packet as a composite message to the RF transmitter 246 for broadcast. Those skilled in the art may determine how to implement the address selecting means 250, as well as the broadcast-frequency selecting means 248, to best fit the design needs of a particular system on a case-by-case basis.

As discussed above, after the address selecting means 250 has been configured or programmed, the data generator 244 receives user input from the interface 242 and generates an instruction message based on user-entered information, i.e. address of module associated with device for which action is directed, and what action, channel selection, for example, should be performed.

The information pertaining to the address associated with the desired device may be formatted as a header, or as another portion of the composite message sent from the data generator 244 to the RF transmitter 246, such that the RF transmitter recognizes the information as a message to be broadcast. Then the RF transmitter transmits the composite message comprising the action instruction and the desired device address from the transmitter antenna 252 at the previously configured frequency. Each remote control device 240 should have a range sufficient enough to reach the control unit mounted on the outside of the house or whatever inside location might be selected by the transmission frequency.

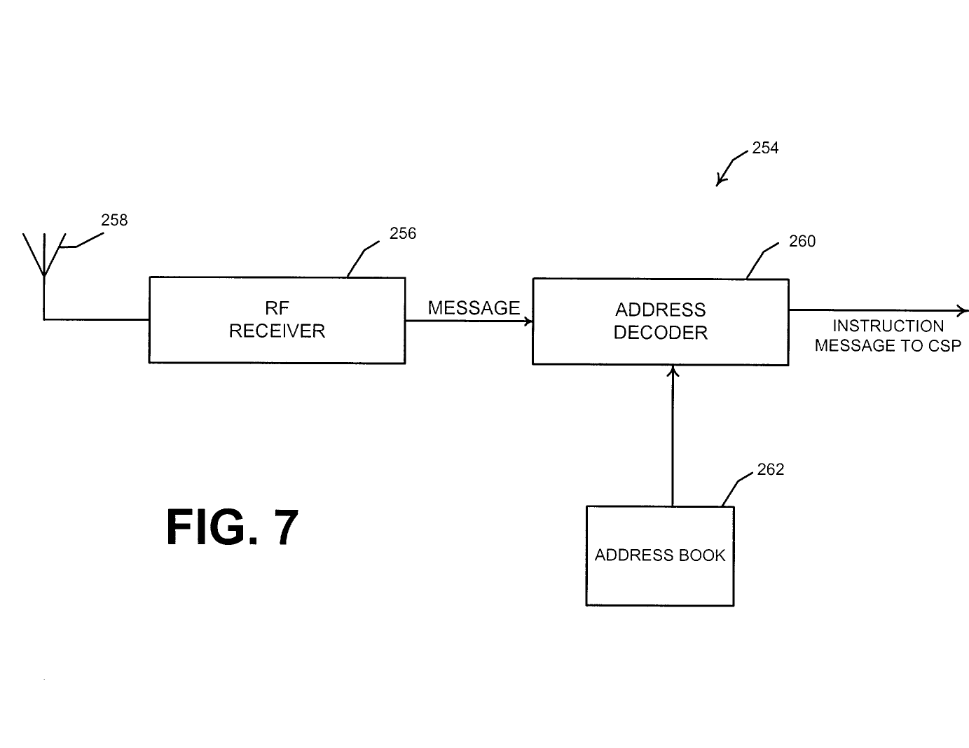

Turning now to FIG. 7, as mentioned previously, the converged services portal can support a wide variety of devices including, for example, televisions, computers and telephones. Moreover, each of these devices may be connected to a disparate module located at the converged services portal to provide addressing ability to each connected multi-media device. Each module may have its own RF receiver 256 and receiving antenna 258 as well as control circuitry designed to detect transmissions from an assigned (i.e. corresponding frequency) remote control 240. Or, a single control module, preferable the network interface module 214, may comprise an RF receiver 256 for receiving an instruction message sent from a remote control transmitter 246, and routing the instruction to the module associated with the desired device based on the module's address.

Regardless of whether each module with an attached media device has its own receiver or whether a single receiver on a control module is used, RF receiver 256 is tuned to detect an RF signal from a remote control transmitter, such as RF transmitter 246 illustrated in FIG. 6. The tuned frequency may typically correspond to the transmit frequency determined by transmit channel selecting means 250 as illustrated in FIG. 6. When a signal sent from transmitter 246 reaches antenna 258 illustrated in FIG. 7, RF receiver 256 detects and demodulates the RF signal so that the information contained therein may be extracted and acted upon. The information contained in the demodulated signal that is output from RF receiver 256 will typically be the same information contained in the signal that was sent from the data generator 244 to the RF transmitter 246, both illustrated in FIG. 6.

The information contained in the composite message extracted from the demodulated signal from RF receiver 256 is sent to address decoder 260 to determine whether a module address was sent along with the instruction message as a composite message. Address decoder searches the combined message for a device address. When an address portion of the message is isolated, the address decoder 260 routes the instruction part of the message to the multi media module that corresponds to the address received in the message. The routing of the instruction to the appropriate device may be facilitated by the data address book means 262. The address book means 262 may be a programmed PROM device, a programmed software device, or jumpers or DIP switches that have been set by a user or installer, for example. Thus, when the address portion has been decoded from the message by the address decoder 260, the address book means 262 guides the address decoder 260 in physically routing the instruction portion of the received message to the desired device module corresponding to the address received in the message. This physical routing may be via an interconnecting data transmission means, such as the backplane 202 and its radio frequency (RF) bus or interface 206 and wireline interface 208 as discussed above in reference to FIG. 2.

Accordingly, a particular module at the converged services portal that is matched both in frequency and data address to a corresponding remote control transmitter device 240, as shown in FIG. 6, can capture keystroke information from the remote control transmitter and process the information according to its operation type (channel select, volume/tone adjust, on/off, VCR programming, etc.) and execute the instruction contained therein, thereby achieving the desired result at the desired media device. Remote control implementation using transmitter device 240 and receiving module 254 can be used with any type of system having a plurality of discrete devices served by a central portal, server, switch, router, or hub. Furthermore, if a scenario does not exist where two or more users with remote control transmitters 240 are likely to be within the reception range of at least one remote control receiver 254, then the address selecting means 250 and address book means 262 may not be necessary. In such a scenario, a remote control transmitter tuned to the same frequency as a receiver of a module corresponding to a single multi-media device can control the device without the sending and decoding of an address message because the instruction message sent by the transmitter would only be routed to the device corresponding to the receiver.

The multi-media devices described herein may include a computer; a personal digital assistant (PDA); a printer; a scanner; a fax machine, at least one web appliance; a heating, ventilation and air-conditioning system; a lighting system; a utility meter; a security system; a fire extinguishing system; a home gaming system; a television; a radio; audio device; intercom; household appliance; doors; windows; cameras; telephones; lawn sprinklers.

It should be understood the present invention includes implementations of other variations and modifications of the invention and its various aspects as may be readily apparent to those of ordinary skill in the art, and that the invention is not limited by the specific embodiments described herein. It is therefore contemplated to cover by the present invention, any and all modifications, variations, or equivalence to fall within the spirit and scope of the basic underlying principles disclosed and claimed herein.

What is claimed is:

1. A system for providing remote control of at least one multi-media device served by a converged multi-media portal that can couple a plurality of multi-media signals carried on a single network medium corresponding to the plurality of multi-media devices comprising:
at least one remote control transmitter for converting a user instruction into an electrical message and transmitting the electrical message wirelessly; and
at least one remote control receiver for wirelessly receiving the wirelessly transmitted electrical message and operating at least one of the plurality of multi-media devices in response to the user instruction represented by the message.

2. The system of claim 1 wherein the remote control transmitter includes a transmit-channel-frequency selecting means.

3. The system of claim 2 wherein the transmit frequency selecting means includes a DIP switch.

4. The system of claim 2 wherein the transmit frequency selecting means includes a jumper arrangement.

5. The system of claim 2 wherein the transmit frequency selecting means includes a programmable memory.

6. The system of claim 5 wherein the programmable memory is programmed when the remote control transmitter is manufactured.

7. The system of claim 5 wherein the programmable memory may be programmed with a user interface.

8. The system of claim 1 wherein the remote control transmitter includes an address selecting means for distinguishing between multi-media devices where more than one of the remote control receivers may be configured to receive electrical signals on the same transmit channel frequency.

9. The system of claim 8 wherein each multi-media device has an associated address that serves as an identifier for selectively directing an instruction message to one or more of the multi-media devices based on an address message contained in the instruction message.

10. The system of claim 8 wherein the address selecting means includes a DIP switch.

11. The system of claim 8 wherein the address selecting means includes a jumper arrangement.

12. The system of claim 8 wherein the address selecting means includes a programmable memory.

13. The system of claim 12 wherein the programmable memory is programmed when the remote control transmitter is manufactured.

14. The system of claim 12 wherein the programmable memory may be programmed with a user interface.

15. The system of claim 8 wherein the remote control transmitter includes a data generator means for combining the user input instruction with an address code received from the address selecting means, the combined instruction and code being converted into the electrical message and sent to an RF transmitter for transmission.

16. The system of claim 1 wherein the at least one remote control receiver includes an RF receiver tuned to a predetermined frequency that is associated with the receiver.

17. The system of claim 1 wherein the at least one remote control receiver includes an address selecting means for associating a predetermined address identifier with the receiver.

18. The system of claim 17 wherein the at least one remote control receiver is associated with one of the multi-media devices.

19. A remote control transmitter for converting a user instruction into an electrical message and transmitting the electrical message wirelessly to a receiver configured to operate at least one multi-media device served by a converged multi-media portal that can couple a plurality of multi-media signals carried on a single network medium to the plurality of corresponding multi-media devices comprising:
a user interface for entering the user instruction;
a data generator for converting the instruction into an electrical instruction message; and
an RF transmitter for transmitting the instruction message to the receiver.

20. The remote transmitter of claim 19 further comprising:
an address selecting means for specifying a particular address corresponding to a particular multi-media device; and
a channel selecting means for determining the frequency at which the RF transmitter transmits, wherein the data generator is configured for combining the instruction message with an address message generated by the address selecting means into a composite message, the composite being transmitted by the RF transmitter.

21. A remote control receiver for wirelessly receiving an electrical message containing a user instruction message, the receiver configured to operate at least one multi-media device served by a converged multi-media portal that can couple a plurality of multi-media signals carried on a single network medium to the plurality of corresponding multi-media devices comprising:
an RF receiver tuned to receive signals transmitted at a predetermined frequency;
an address decoder; and
an address selecting means for predetermining an address to be associated with a multi-media device served by the receiver, the address decoder being configured for decoding and separating an address message from a received composite message, for comparing the address from the composite message to the predetermined address set at the address selecting means, and for passing the instruction message to the multi-media device associated with the predetermined address if the address in the address message matches the predetermined address.

22. A method for remotely controlling at least one multi-media device served by a converged multi-media portal that can couple a plurality of multi-media signals carried on a single network medium corresponding to the plurality of multi-media devices comprising:
receiving a user instruction for operating one of the at least one multi-media devices through a user interface;
converting the user instruction into an instruction message;
transmitting the instruction message wirelessly with an RF transmitter at an RF frequency.

23. The method of claim 22 further comprising the step of selecting the RF frequency with a transmit-channel-selecting means.

24. The method of claim 22 further comprising:
selecting with an address selecting means an address corresponding to the multi-media device to be operated;
generating an address message based on the selected address;
combining the address message with the instruction message into a composite message; and
transmitting the composite message wirelessly with the RF transmitter at the RF frequency.

25. A method for remotely controlling at least one multi-media device served by a converged multi-media portal that can couple a plurality of multi-media signals carried on a single network medium corresponding to the plurality of multi-media devices comprising:
receiving a wirelessly transmitted RF message with an RF receiver tuned to the carrier frequency of the RF message, the message including a user instruction to operate a multi-media device;
determining whether the message contains an address message corresponding to a multi-media device served by the receiver; and
routing the instruction message toward a multi-media device, wherein the multimedia device corresponds to the address in the address message if the received RF message contains an address message.
